(19) United States
(12) Patent Application Publication
(10) Pub. No.: US 2014/0136884 A1
(43) Pub. Date: May 15, 2014

(54) READ DISTURB HANDLING FOR NON-VOLATILE SOLID STATE MEDIA

(71) Applicant: LSI CORPORATION, Milpitas, CA (US)

(72) Inventors: Jeremy Werner, San Jose, CA (US); Earl T. Cohen, Oakland, CA (US); Timothy L. Canepa, Los Gatos, CA (US)

(73) Assignee: LSI CORPORATION, Milpitas, CA (US)

(21) Appl. No.: 13/729,966

(22) Filed: Dec. 28, 2012

Related U.S. Application Data
(63) Continuation-in-part of application No. 13/677,938, filed on Nov. 15, 2012.

(51) Int. Cl. G06F 11/20

(52) U.S. Cl. CPC G06F 11/2094
USPC 714/6.11

(57) ABSTRACT

Described embodiments track a read disturb limit of a solid-state media coupled to a media controller. The media controller receives a read operation from a host device. In response to the received read operation, the media controller determines one or more associated regions of the solid-state media accessed by the read operation and reads the associated regions to provide read data to the host device. Based on a probability value corresponding to each of the associated regions, the media controller selectively increments a read count of each of the associated regions. Based upon each read count, the media controller determines whether each region has reached a read disturb limit. If a given region has reached the read disturb limit, the media controller relocates data of the given region to a free region of the solid-state media. Otherwise, the media controller maintains the data in the given region.

### CROSS-REFERENCE TO RELATED APPLICATIONS

This application is a continuation-in-part, and claims the benefit of the filing date, of U.S. patent application Ser. No. 13/677,938 filed Nov. 15, 2012, the teachings of which are incorporated herein in their entireties by reference.

### BACKGROUND

Flash memory is a non-volatile memory (NVM) that is a specific type of electrically erasable programmable read-only memory (EEPROM). One commonly employed type of flash memory technology is NAND flash memory. NAND flash memory requires small chip area per cell and has high endurance. However, the I/O interface of NAND flash memory does not provide full address and data bus capability and, thus, generally does not allow random access to memory locations.

NAND flash chips are typically divided into one or more banks or planes. Each bank is divided into blocks; each block is divided into pages. Each page includes a number of bytes for storing user data, error correction code (ECC) information, or both. There are three basic operations for NAND devices: read, write and erase. The read and write operations are performed on a page-by-page basis. Page sizes are generally 2^{N} bytes of user data (plus additional bytes for ECC information), where N is an integer, with typical user data page sizes of, for example, 2,048 bytes (2 KB), 4,096 bytes (4 KB), 8,192 bytes (8 KB) or more per page. Pages are typically arranged in blocks, and an erase operation is performed on a block-by-block basis. Typical block sizes are, for example, 64, 128 or more pages per block. Pages must be written sequentially, usually from a low address to a high address within a block. Lower addresses cannot be rewritten until the block is erased. Associated with each page is a spare area (typically 100-640 bytes) generally used for storage of ECC information and/or other metadata used for memory management. The ECC information is generally employed to detect and correct errors in the user data stored in the page, and the metadata might be used for mapping logical addresses to and from physical addresses. In NAND flash chips with multiple banks, multi-bank operations might be supported that allow pages from each bank to be accessed substantially in parallel. Multi-bank programming, for example, improves write bandwidth by writing data to a page in each bank substantially in parallel.

NVMs, such as NAND flash chips, suffer from a phenomenon called “read disturb”. Read disturb refers to a condition where reading one cell in a NAND string (e.g., one bit of one page in a block) can cause errors in (“disturb”) other bits in the same NAND string. The other bits are affected because to read one bit in a NAND string, a bypass current is applied to the gates of all the other bits in the NAND string. The bypass current can act as a weak form of programming, thus changing the charge distribution of the other bits and causing errors to accumulate in the other bits.

Reading a single page repeatedly will not cause read disturb errors on that page. However, the other pages in the same block (e.g., pages sharing the same NAND strings) as the page being read can be disturbed and can accumulate additional errors. The read disturb phenomenon is one source of errors in NAND flash. Other sources of errors might include (i) program disturb, (ii) retention, and (iii) erase and program noise. Program disturb errors are caused by inter-cell interference due to initial programming of adjacent cells. Retention errors are caused by loss of charge over time in a given cell. Erase and program noise errors are due to imperfect erasing and/or programming.

A conventional method for preventing data loss due to the above errors is for a vendor to specify an error correction level that accounts for these effects, within certain limits For example, devices might be rated with a vendor-specified “read disturb limit”. The read disturb limit is a number of reads of a given block after which the data in that block will be so disturbed (e.g., will have accumulated so many additional errors due to the reading operations) that the given block should be re-written to a new location, and the given block erased. The erased block can then be used as “new” to store other data. Thus, if a read count of a block (e.g., a count of the number of reads since the last program/erase of the block) is kept below the vendor-specified “read disturb limit”, then read disturbs will not cause excess errors beyond a rated error correction level. Similarly, a retention rating is typically provided such that retention loss will not cause excess errors over a specified period of time as long as the NAND flash chips are kept within a specified temperature range.

Each “read” in the read disturb limit is defined as a sequential read of all of the pages in a given block. For example, a read disturb limit of 30K would mean that a given block, once programmed, can be sequentially read 30K times before the cells become so disturbed as to need corrective action. However, read operations are not typically performed in the sequential fashion assumed by the vendor limits—reading is, in some usage scenarios, effectively a random process. Assuming the reads are randomly distributed, read disturb handling is typically performed by counting a number of times NAND flash pages are read in each block (as one example, one counter per block that is incremented every time there is a NAND flash page read in that block).

However, implementing such counters might require a large amount of storage. Tracking read disturb on a page basis is possible but very costly as the “disturbed” pages are all the ones not read, so either reading one page must increment the counts for all the others, or read disturb must be detected for a page when the sum of the read counts of all other pages exceeds a limit. For example, in a NAND flash having 128 pages per block, the read disturb limit for an entire block approaches 4M page reads, which would require a 22-bit counter for the block. With, for example, 1K blocks per flash die and 32 die in a typical solid-state disk (SSD), block-based read disturb counters require 96 KB of high-speed (generally, on-chip) storage, which is a large amount for a typical SSD controller. Further, with technology improvements, these parameters are increasing in some configurations (e.g., 256 pages per block, 2K blocks per die, larger SSD capacity, etc.). Although the granularity over which read disturbs are measured might be changed (e.g., one counter per groups of blocks), or the range of the counters might be reduced, such trade-offs negatively impact SSD performance.

Further, read disturb limits generally decrease over NVM lifetime since, as the NVM wears (e.g., over program/erase cycles for NAND flash), the read disturb limit typically decreases. For example, an multi-level cell (MLC) NAND chip might have a read disturb limit of 30K near the beginning of its life (few program/erase cycles), but perhaps only 3K near the end of its life (at or near the rated number of program/erase cycles).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments track a read disturb limit of a solid-state media coupled to a media controller. The media controller receives a read operation from a host device. In response to the received read operation, the media controller determines one or more associated regions of the solid-state media accessed by the read operation and reads the associated regions to provide read data to the host device. Based on a probability value corresponding to each of the associated regions, the media controller selectively increments a read count of each of the associated regions. Based upon each read count, the media controller determines whether each region has reached a read disturb limit. If a given region has reached the read disturb limit, the media controller relocates data of the given region to a free region of the solid-state media. Otherwise, the media controller maintains the data in the given region.

### BRIEF DESCRIPTION OF THE DRAWING FIGURES

Other aspects, features, and advantages of described embodiments will become more fully apparent from the following detailed description, the appended claims, and the accompanying drawings in which like reference numerals identify similar or identical elements.

FIG. 1 shows a block diagram of a flash memory storage system in accordance with exemplary embodiments;

FIG. 2 shows an exemplary functional block diagram of a single standard flash memory cell;

FIG. 3 shows an exemplary NAND MLC flash memory cell, in accordance with exemplary embodiments of the present invention;

FIG. 4 shows an exemplary diagram of the threshold voltages of the MLC NAND flash cell of FIG. 3;

FIG. 5 shows a flow diagram of a read disturb limit tracking process of the flash memory storage system of FIG. 1 in accordance with exemplary embodiments;

FIG. 6 shows a flow diagram of a subprocess for initializing read disturb counters of the read disturb limit tracking process of FIG. 5 in accordance with exemplary embodiments; and

FIG. 7 shows a flow diagram of a subprocess for determining one or more probability values of the read disturb limit tracking process of FIG. 5 in accordance with exemplary embodiments.

### DETAILED DESCRIPTION

Described embodiments track a read disturb limit of a solid-state media coupled to a media controller. The media controller receives a read operation from a host device. In response to the received read operation, the media controller determines one or more associated regions of the solid-state media accessed by the read operation and reads the associated regions to provide read data to the host device. Based on a probability value corresponding to each of the associated regions, the media controller selectively increments a read count of each of the associated regions. Based upon each read count, the media controller determines whether each region has reached a read disturb limit. If a given region has reached the read disturb limit, the media controller relocates data of the given region to a free region of the solid-state media. Otherwise, the media controller maintains the data in the given region.

Table 1 defines a list of acronyms employed throughout this specification as an aid to understanding the described embodiments:

TABLE 1

| | | | |
|---|---|---|---|
| BER | Bit Error Rate | ECC | Error Correction Code |
| EEPROM | Electrically erasable | | |
| | programmable | | |
| | read-only memory | | |
| IC | Integrated Circuit | LDPC | Low-Density Parity-Check |
| LLR | Log-Likelihood Ratio | LSB | Least Significant Bit |
| MLC | Multi-Level Cell | MSB | Most Significant Bit |
| NVM | Non-Volatile Memory | PCI-E | Peripheral Component |
| | | | Interconnect Express |
| P/E | Program/Erase | SAS | Serial Attached SCSI |
| SATA | Serial Advanced | SCSI | Small Computer System |
| | Technology | | Interface |
| | Attachment | | |
| SoC | System on Chip | SRIO | Serial Rapid Input/Output |
| SSD | Solid-State Disk | USB | Universal Serial Bus |

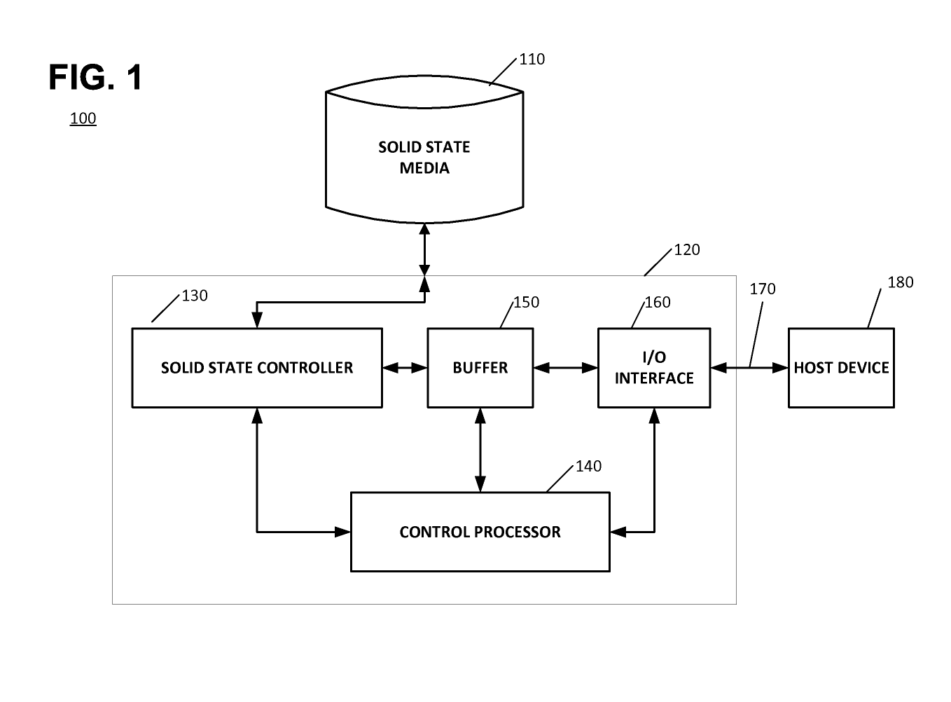

FIG. 1 shows a block diagram of flash memory storage system 100. Flash memory storage system 100 includes solid state media 110, which is coupled to media controller 120. Media controller 120 includes solid state controller 130, control processor 140, buffer 150 and I/O interface 160. Media controller 120 controls transfer of data between solid state media 110 and host device 180 that is coupled to communication link 170. Media controller 120 might be implemented as a system-on-chip (SoC) or other integrated circuit (IC). Solid state controller 130 might be used to access memory locations in solid state media 110, and might typically implement low-level, device specific operations to interface with solid state media 110. Buffer 150 might be a RAM buffer employed to act as a cache for control processor 140 and/or as a read/write buffer for operations between solid state media 110 and host device 180. For example, data might generally be temporarily stored in buffer 150 during transfer between solid state media 110 and host device 180 via I/O interface 160 and link 170. Buffer 150 might be employed to group or split data to account for differences between a data transfer size of communication link 170 and a storage unit size (e.g., page size, sector size, or mapped unit size) of solid state media 110. Buffer 150 might be implemented as a static random-access memory (SRAM) or as an embedded dynamic random-access memory (eDRAM) internal to media controller 120, although buffer 150 could also include memory external to media controller 120 (not shown), which might typically be implemented as a double-data-rate (e.g., DDR-3) DRAM.

Control processor 140 communicates with solid state controller 130 to control data access (e.g., read or write operations) data in solid state media 110. Control processor 140 might be implemented as a Pentium®, Power PC®, Tensilica® or ARM processor type (Pentium® is a registered trademark of Intel Corporation, Tensilica® is a trademark of Tensilica, Inc., ARM processors are by ARM Holdings, plc, and Power PC® is a registered trademark of IBM). Although shown in FIG. 1 as a single processor, control processor 140 might be implemented by multiple processors (not shown) and include software/firmware as needed for operation, including to perform threshold optimized operations in accordance with described embodiments.

Communication link 170 is used to communicate with host device 180, which might be a computer system that interfaces with solid state storage system 110. Communication link 170 might be a custom communication link, or might be a bus that operates in accordance with a standard communication protocol such as, for example, a Small Computer System Interface (“SCSI”) protocol bus, a Serial Attached SCSI (“SAS”) protocol bus, a Serial Advanced Technology Attachment (“SATA”) protocol bus, a Universal Serial Bus (“USB”), an Ethernet link, an IEEE 802.11 link, an IEEE 802.15 link, an IEEE 802.16 link, a Peripheral Component Interconnect Express (“PCI-E”) link, a Serial Rapid I/O (“SRIO”) link, or any other similar interface link for connecting a peripheral device to a computer.

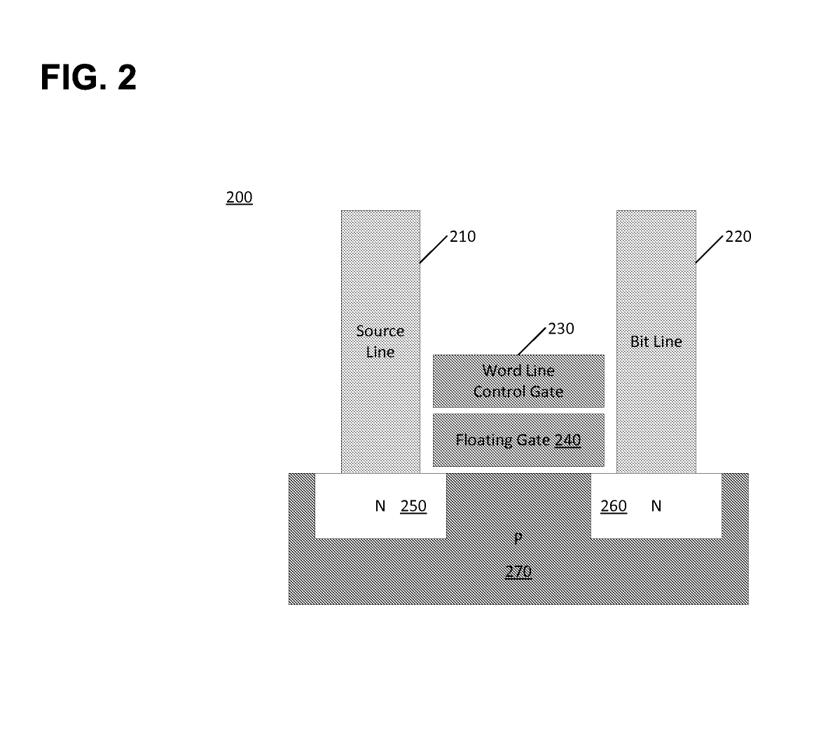

FIG. 2 shows an exemplary functional block diagram of a single flash memory cell that might be found in solid state media 110. Flash memory cell 200 is a MOSFET with two gates. The word line control gate 230 is located on top of floating gate 240. Floating gate 240 is isolated by an insulating layer from word line control gate 230 and the MOSFET channel, which includes N-channels 250 and 260, and P-channel 270. Because floating gate 240 is electrically isolated, any charge placed on floating gate 240 will remain and will not discharge significantly, typically for many months. When floating gate 240 holds a charge, it partially cancels the electrical field from word line control gate 230 that modifies the threshold voltage of the cell. The threshold voltage is the amount of voltage applied to control gate 230 to allow the channel to conduct. The channel's conductivity determines the value stored in the cell. In multi-level cell, the amount of current flow is sensed in order to determine the precise charge on floating gate 240.

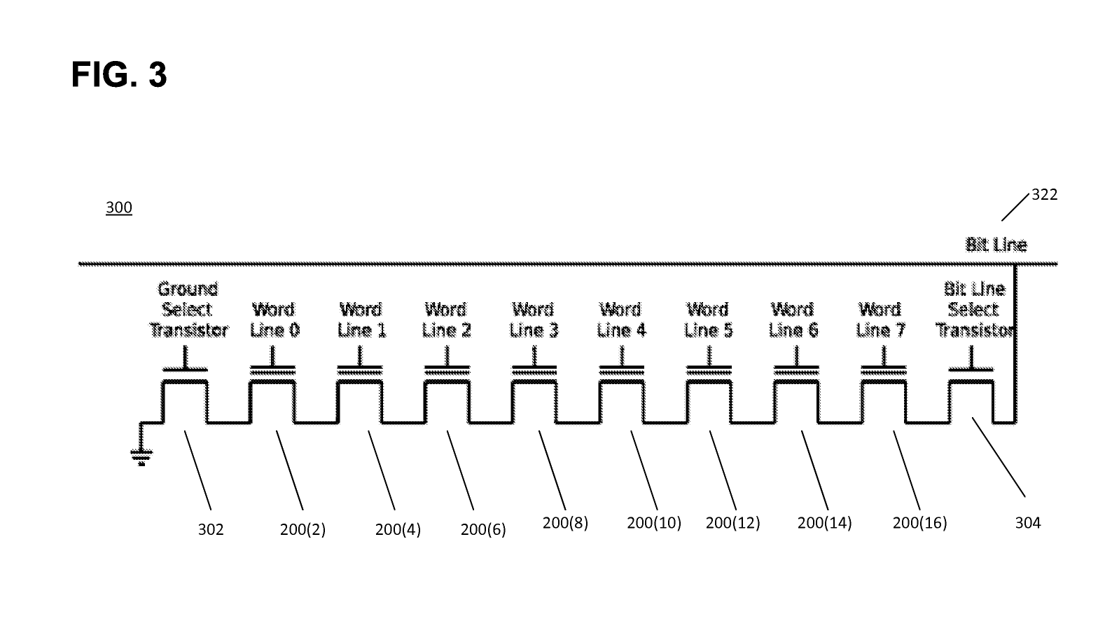

FIG. 3 shows an exemplary NAND MLC flash memory string 300 that might be found in solid state media 110. As shown in FIG. 3, flash memory string 300 might include one or more word line transistors 200(2), 200(4), 200(6), 200(8), 200(10), 200(12), 200(14), and 200(16) (e.g., 8 flash memory cells), and bit line select transistor 304 connected in series, drain to source. This series connection is such that ground select transistor 302, word line transistors 200(2), 200(4), 200(6), 200(8), 200(10), 200(12), 200(14) and 200(16), and bit line select transistor 304 are all “turned on” (e.g., in either a linear mode or a saturation mode) by driving the corresponding gate high in order for bit line 322 to be pulled fully low. Varying the number of word line transistors 200(2), 200(4), 200(6), 200(8), 200(10), 200(12), 200(14), and 200(16), that are turned on (or where the transistors are operating in the linear or saturation regions) might enable MLC string 300 to achieve multiple voltage levels.

As described herein, in MLC NAND flash, each cell has a voltage charge level (e.g., an analog signal) that can be sensed, such as by comparison with a read threshold voltage level. A media controller might have a given number of predetermined voltage thresholds employed to read the voltage charge level and detect a corresponding binary value of the cell. For example, if there are 3 thresholds (0.1, 0.2, 0.3), when a cell voltage level is 0.0≦cell voltage<0.1, the cell might be detected as having a value of [00]. If the cell voltage level is 0.1≦cell voltage<0.2, the value might be [10], and so on. Thus, described embodiments might compare a measured cell level to the thresholds one by one, until the cell level is determined to be in between two thresholds and can be detected. Thus, detected data values are provided to a decoder of memory controller 120 to decode the detected values (e.g., with an error-correction code) into data to be provided to host device 180.

Some embodiments might employ Low-Density Parity-Check (LDPC) decoders to decode data stored in MLC flash memory. LDPC decoders are very powerful and can approach the Shannon limit in terms of their correction ability. Unlike algebraic codes, though, LDPC codes do not have a fixed correction ability (such as in bits of errors correctable per codeword). Further, LDPC codes are susceptible to trapping sets in their Tanner graph creating an “error floor”—a change in the normal “waterfall” characteristic of output bit-error-rate versus input bit-error-rate where the output bit-error-rate suddenly changes to a much less steep slope. However, to more efficiently employ LDPC codes, “soft” data, such as the analog-like probability that each bit being decoded has a given value, or the precise charge level of the cells, might be employed. The probability is generally specified as a Log-Likelihood Ratio (LLR). In MLC NAND flash memories, for example, the ability to move the threshold voltage for bit detection during read operations enables taking multiple samples of the bit values to determine how reliable each bit is, and this reliability can then be expressed as an LLR for each bit.

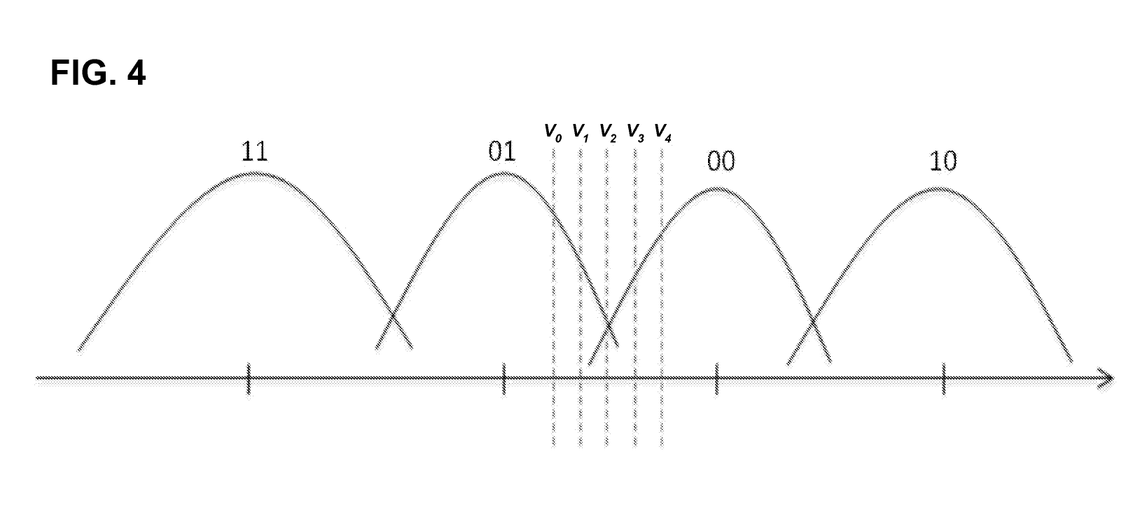

FIG. 4 shows an exemplary diagram of the threshold voltages of an MLC NAND flash cell such as shown in FIG. 3. As shown in FIG. 4, moving a threshold voltage (V₀, V₁, V₂, V₃, V₄, V₅) used to read an MLC NAND flash cell might change the observed state (read value) of the bit. The four states are the (Gray coded) MLC states 11, 01, 00, and 10. FIG. 4 shows an exemplary histogram of the charge distribution (via a read voltage level) of each of the four states across a large number of cells. When reading the least significant bit (LSB) as shown in FIG. 4, voltages less than the threshold reference are read as a 1. As can be seen, V₄ will tend to sample more bits as 1, and V₀ will tend to sample more bits as 0. Further, bits sampled by V₂, in the center of the two distributions, are sometimes indeterminate. Based on exactly where each cell has its voltage threshold (crossing from 1 to 0), a likelihood that the cell is actually holding a 1 or 0 can be determined As described herein, a part of soft-decision LDPC decoding of NAND flash memory is turning one or more reads of the NAND flash (each at a different threshold voltage) into an LLR for each bit position.

As described herein, a typical MLC NAND flash might employ a “NAND string” (e.g., as shown in FIG. 3) of 64 transistors with floating gates. During a write operation, a high current is applied to the NAND string. During a read operation, a voltage is applied to the gates of all transistors in the NAND string except a transistor corresponding to a desired read location. The desired read location has a floating gate. Thus, NAND flash chips suffer from a phenomenon called “read disturb”. Read disturb refers to a condition where reading one cell in a NAND string (e.g., one bit of one page in a block) can cause errors in (“disturb”) other bits in the same NAND string. The other bits are affected because to read one bit in a NAND string, a bypass current is applied to the gates of all the other bits in the NAND string. The bypass current can act as a weak form of programming, thus changing the charge distribution of the other bits and causing errors to accumulate in the other bits.

NAND flash manufacturers specify a read disturb limit of a maximum number of sequential reads for each block (ex.: X sequential reads of each block). The read disturb limit defines that, once programmed, a given block can be sequentially read X times before the read disturb effect might corrupt data to the point where the data is uncorrectable and, thus, unrecoverable. If there are P pages per block, then the read disturb limit implies that any given page can be disturbed (P-1)*X times before it is disturbed enough to violate the vendor-specified limits. That is, each page is allowed to see the disturb effects of reading P-1 other pages X times without exceeding the vendor-specified ECC limits.

For example, in a system having P pages per block and a read disturb limit of X, the read disturb limit for a block is (P-1)*X. If read accesses are tracked for the entire block, a counter having [log₂(P-1)*X] bits is required to count up to the full read disturb limit. It is desirable for the read-disturb counter to have reasonable size, granularity and accuracy since: (1) if the counter is not large enough to count to the full read-disturb limit, pages will be moved more often than necessary due to falsely believing there might be a read disturb issue; and (2) if the counter is not of sufficient granularity or accuracy, the system could exceed the read disturb limit. Although the read disturb limit is a suggested limit and exceeding the read disturb limit by a small amount is likely of minimal impact, exceeding the read disturb limit by larger values implies more errors in stored data, and at some point, disturbed pages might become unrecoverable, resulting in loss of data.

Described embodiments reduce the space required to store accurate read disturb counts. While accuracy is needed in the read disturb counts, the range being counted is so large that a small inaccuracy can be exchanged for a large savings in storage space. Such a savings in storage space is achieved by performing a randomized read disturb count using a probabilistic counter. In described embodiments, instead of incrementing a read disturb count for each read to a given block, each read is counted probabilistically by incrementing a read disturb count only a determined fraction of the time, φ. In described embodiments, φ is used probabilistically, for example, by employing a comparison value generated by using: (i) a pseudo-random number generator (PRNG) or (ii) a real-time clock, assuming the least significant bits (LSBs) are effectively random. The comparison value is, or is normalized to be, in a zero to one range, and is then compared to see if it more or less than φ. The read disturb count is only incremented the determined fraction of the time (e.g., read disturb count is incremented for φ of the reads), for example by selectively incrementing the read disturb count if the comparison value is less than φ. In some embodiments, a single value of φ might be employed for all blocks, assuming that reads are randomly spread between all blocks (e.g., all read disturb counts are only incremented φ of the time). In other embodiments, various regions of the NAND flash might employ unique values of φ based on measured usage statistics or based on different characteristics of each region of the flash memory. For example, given regions might employ different page sizes or might employ different modes of flash memory (e.g., SLC vs. MLC, etc.). According to various embodiments, there are multiple ways to perform the probabilistic increment. For example, the normalization of the comparison value and/or of φ could be over any determined range, and the comparison could be any arithmetic comparison such as less than, less than or equal to, greater than, or greater than or equal to. In other words, φ is a probabilistic value having a mean that can be represented by a fraction, and having a standard deviation of x, where if x=0, φ is exact.

If φ is <<0.5, then each read disturb counter can be approximately [log₂(1/φ] smaller than required if all reads are counted. For example, if

$$ϕ = \frac{1}{256} ,$$

each probabilistic read disturb counter could be log₂(256)=8 bits shorter than an equivalent non-probabilistic counter. In a typical NAND flash memory, the manufacturer's read disturb limit might be 4 million reads. Thus, in an exemplary system employing probabilistic counters that only increment

$$ϕ = \frac{1}{256} th$$

of the time, where (P-1)*X=4M, a 22-bit counter was required to count every read in a given block, but employing a probabilistic counter allows a 22−8=14-bit counter to be used.

A 14-bit counter that incremented approximately 1/256th of the time would saturate after approximately 16K*256=4M reads. The standard deviation expected with 4M reads with probability 1/256 is approximately 127.75. Thus, the probability of being more than 6 standard deviations (˜777 reads) off from the manufacturer's read disturb limit is less than 1/500M. In this exemplary case, reducing the threshold for detecting a read disturb by 777 (e.g., from 2¹⁴−1 to 2¹⁴−778=15606), the probability of not detecting exceeding the specified read disturb limit (4M) is less than 1/1B (one in one billion). Thus, the probability φ might be adjusted to select between reducing the size of the counters and increasing the accuracy of the counting. This might be desirable since, generally, exceeding the read disturb limit by a small amount is not critical.

Further, the probability φ can be changed over the lifetime of the solid state memory. As described, the read disturb limit typically decreases as the flash memory ages over many program/erase cycles during its usage lifetime. Although it is possible to lower the counting threshold of the probabilistic counters (effectively using fewer bits of the counter), in described embodiments, the value of φ is increased so the same number of bits of the probabilistic counter are employed. In the exemplary embodiment employing 14-bit probabilistic counters, if the read disturb limit reduced from 4M to 1M over the lifetime of the flash memory, then the probability φ should be increased from

$$ϕ = \frac{1}{256} to ϕ = \frac{1}{64} .$$

The standard deviation remains approximately the same (approximately 124 in this example).

Further, the probability φ might be reduced more than once during the lifetime of the flash memory. For example, if the read disturb limit reduced to 256K later in life, φ might be decreased to

$$ϕ = \frac{1}{16} .$$

In the event φ becomes 1, the entire probabilistic counter is used and behaves as a normal counter (e.g., counts every read operation). In other embodiments, the limit value of the counter (the point at which read disturbs are detected) might also be changed alone or in conjunction with changing φ. In described embodiments, lifetime of the flash memory might be determined based on media controller 120 tracking a number of program/erase (P/E) cycles performed on each block of the NVM. Media controller 120 might typically perform wear-leveling to attempt to keep all blocks of the NVM having similar P/E counts.

In addition to the read disturb phenomenon, a related issue with NVMs is a “read disturb storm”. A read disturb storm refers to the possible situation of a large number of read disturb counters all reaching the limit value (where read disturbs are detected) at a same time. In such an instance, a large number of pages would need to be relocated on the flash memory at (or very near) the same moment in time, which could negatively affect performance of system 100. Described embodiments prevent read disturb storms by assigning the initial values of the read disturb counters to be distributed, such as randomly distributed, over a range. This prevents likely data patterns, such as purely sequential access, from causing all of the read disturb counters to trigger a read disturb indication at substantially the same time.

The range over which the initial values of the read disturb counters are distributed might be selected to trade off when a first one of the read disturb counters reaches the limit versus a number of the read disturb counters that can reach the limit at or near the same time. For example, if the initial values are spread out over the entire range of the read disturb limit, then some counters with an initial value closer to the read disturb limit would signal a read disturb after relatively few reads, but the counters are spread out so much that the number of the counters that can reach the limit at or near the same time is, with high probability, very small. If the initial values are spread out over, for example, just a subset of the entire range of the read disturb limit (e.g., the first half of the range), then none of the read disturb counters are likely to quickly reach the read disturb limit, but the number of counters that could reach the limit at or near the same time is increased compared to the case of spreading the initial values over the entire range. Since blocks are frequently recycled and re-used, it might actually be rare, particularly early in life of the flash memory, for blocks to reach the read disturb limit, except for outlying benchmarks such as purely sequential, read-only access. Accordingly, spreading the read disturb counter initial values over only over a portion of the range is likely sufficient for most applications.

Another technique to prevent a read disturb storm is to modify the value of φ on a per-block basis. For example, if the value of φ for block i, φᵢ, was

$${ϕ}_{i} = ϕ + \frac{i}{N} ,$$

then even if all of the per-block read disturb probabilistic counters started at a same value, varying per-block probability would ensure with high probability that the counters would reach their limits at different times, thus avoiding a read disturb storm. The number of counters that could reach their limit at or near the same time can be adjusted by varying the range of the probability difference among the blocks (e.g., varying N). In some embodiments, N might typically be selected to be 1M. In other embodiments, N might typically be selected to be proportional to a current read disturb limit.

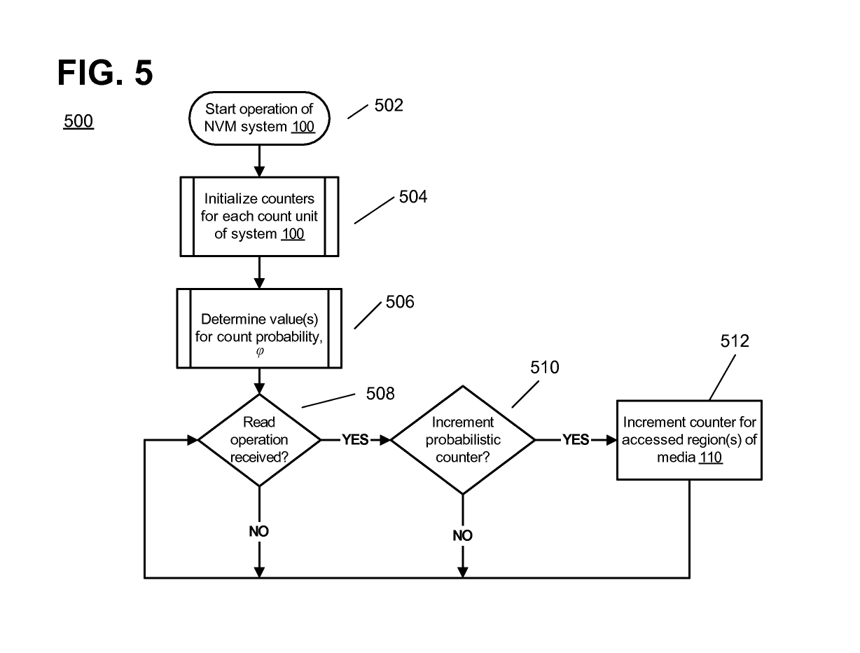

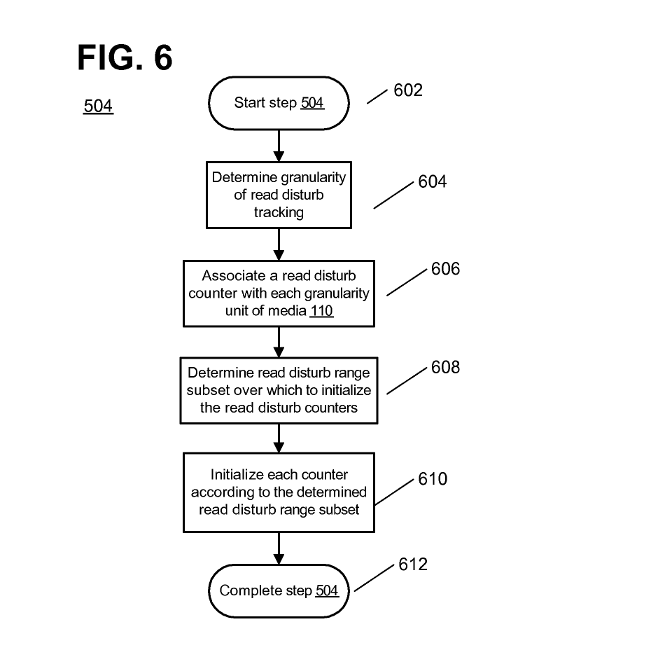

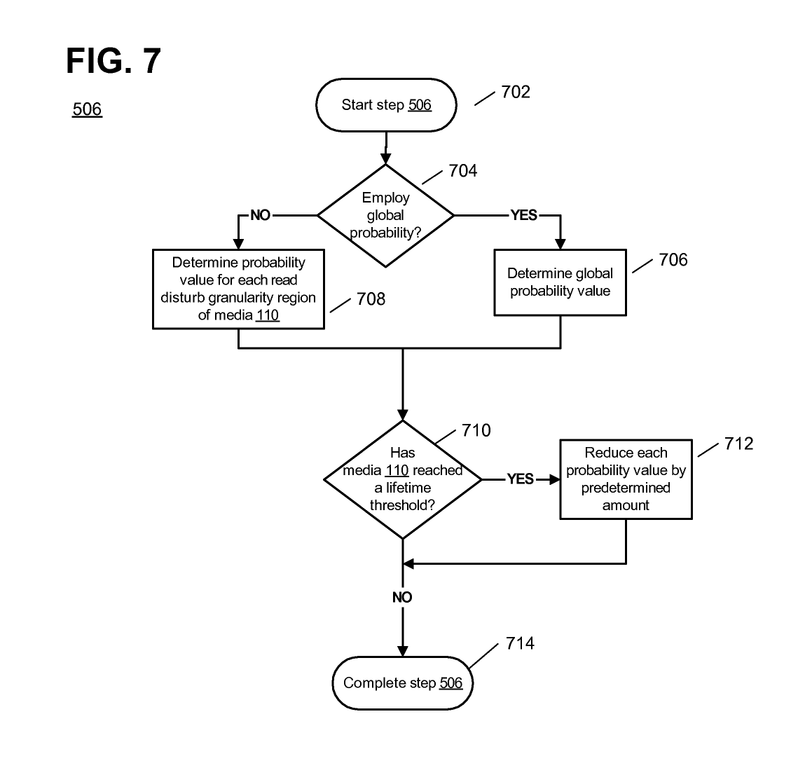

FIG. 5 shows a flow diagram of read disturb limit tracking process 500. At step 502, process 500 starts, for example at power up of NVM system 100. At step 504, read disturb counters of system 100 are initialized. As described herein, there might be a read disturb counter corresponding to each of one or more read disturb tracking regions of media 110. In one embodiment, each block of media 110 has a corresponding read disturb counter. Additional detail of step 504 is shown in FIG. 6. At step 506, the probability value, φ, is determined As described herein, system 100 might employ different values of φ for each read disturb tracking region. Further, the value of φ might change over the lifetime of media 110. Additional detail of step 506 is shown in FIG. 7. Although shown in FIG. 5 as occurring at a start-up of system 100, some embodiments of system 100 periodically perform step 506 to adjust the probability value(s) over the lifetime (e.g., a number of P/E cycles) of media 110. For example, step 506 might be re-performed at predefined P/E cycle thresholds. Step 506 might typically be performed by media controller 120 in the background during otherwise idle time of the media controller so as to avoid reducing system performance.

At step 508, if a read operation of media 110 is received from host device 180, then at step 510, control processor 140 determines, based on the value of φ, whether to increment a probabilistic counter associated with the region(s) of media 110 accessed by the received read operation. If, at step 510, control processor 140 determines to increment an associated probabilistic counter, then at step 512, the corresponding counter(s) are incremented and process 500 returns to step 508 to wait for a read operation to be received (other operations of system 100 might be performed while waiting for a read operation to be received). If, at step 510, control processor 140 determines not to increment an associated probabilistic counter, then process 500 returns to step 508 to wait for a read operation to be received (other operations of system 100 might be performed while waiting for a read operation to be received). If, at step 508, a read operation is not received, then read disturb tracking process 500 remains at step 508 to wait for a read operation to be received (other operations of system 100 might be performed while waiting for a read operation to be received).

FIG. 6 shows additional detail of step 504 of read disturb limit tracking process 500. At step 602, subprocess 504 starts. At step 604, control processor 140 determines a granularity for read disturb tracking of media 110. For example, control processor 140 might determine, based on user-configurable settings, whether to track read operations on a page-by-page basis, a block-by-block basis, based on some other region basis of media 110, or some combination thereof. At step 606, control processor 140 associates a read disturb counter with each granularity region determined at step 604. At step 608, control processor 140 determines a subset of the range of the read disturb limit over which to initialize the various read disturb counters. As described herein, this reduces the likelihood of a “read disturb storm”. In some embodiments, the subset of the range might be approximately equal to half of the read disturb limit, although the subset could be the entire range, none of the range (e.g., all the counters are initialized to the same value), or any other value less than the read disturb limit. At step 610, control processor 140 initializes each counter to a corresponding initial value based on the range subset determined at step 608. Each corresponding initial value might be determined, for example, to be at given intervals within the range subset or substantially at random within the range subset (e.g., by employing a pseudo-random number generator). At step 612, subprocess 504 completes.

FIG. 7 shows additional detail of step 506 of read disturb limit tracking process 500. At step 702, subprocess 506 starts. At step 704, control processor 140 determines whether a global probability value, φ, is employed, or whether varying probability values, φᵢ, are employed for each of i granularity regions of media 110 (e.g., for each block). If, at step 704, a global probability value, φ, is employed, the global probability value is determined at step 706. For example, the global probability value might be determined based on a user-configurable setting of system 100. Further, the global probability value might change over time, such as changing as system 100 ages over increasing program/erase cycles of the NVM. If, at step 704, varying probability values, φᵢ, are employed for each of i granularity regions of media 110 (e.g., for each block), then at step 708, each of the i probability values are determined For example, the probability values might be determined based on a user-configurable setting of system 100 and one or more usage statistics of media 110. Further, one or more (or all) of the probability values per granularity region might change over time, such as changing as system 100 ages over increasing program/erase cycles of the NVM. Described embodiments employ varying probability values for the different granularity regions of the NVM since program/erase cycles are not necessarily uniform across all NVM regions.

After either step 706 or step 708, at step 710, control processor 140 determines whether media 110 has reached a lifetime threshold. For example, the lifetime threshold might be determined as a threshold number of program/erase (P/E) cycles of the NVM. If, at step 710, a lifetime threshold has been reached, then at step 712, the probability values are reduced by a predetermined value and subprocess 506 completes at step 714. For example, in some embodiments, the read disturb limits might be decreased to specified values (or by specified amounts) at determined known P/E cycle thresholds over the lifetime of the NVM. For example, when the P/E cycle count reaches approximately one-third to one-half of the maximum P/E threshold, the probability values might be decreased a first time. The probability values might be decreased at thresholds of increasing frequency as the number of P/E cycles increase and become closer to (or exceed) the maximum P/E threshold. If, at step 710, a lifetime threshold has not yet been reached, then subprocess 506 completes at step 714.

Although described herein as MLC NAND flash, described embodiments might be employed with other types of NVM. Further, described embodiments might be employed with hybrid or heterogeneous NVMs that are implemented with two or more types of NVM with different properties or characteristics. The read disturb counts can be tracked over regions of differing granularities. Although generally described herein as counting up to a maximum threshold value, other embodiments alternatively might count down to a minimum threshold value. Any thresholds or limits may be specified in advance (e.g., in software program code running on control processor 140), might be set as user-configurable settings (e.g., in registers of control processor 140), or might be functions of any other counts or usage statistics maintained and tracked by system 100. For example, in some embodiments, the read disturb count threshold might be based on block error statistics (e.g., a BER of read blocks).

Thus, as described herein, described embodiments track a read disturb limit of a solid-state media coupled to a media controller. The media controller receives a read operation from a host device. In response to the received read operation, the media controller determines one or more associated regions of the solid-state media accessed by the read operation and reads the associated regions to provide read data to the host device. Based on a probability value corresponding to each of the associated regions, the media controller selectively increments a read count of each of the associated regions. Based upon each read count, the media controller determines whether each region has reached a read disturb limit. If a given region has reached the read disturb limit, the media controller relocates data of the given region to a free region of the solid-state media. Otherwise, the media controller maintains the data in the given region.

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

While the exemplary embodiments have been described with respect to processing blocks in a software program, including possible implementation as a digital signal processor, micro-controller, or general-purpose computer, described embodiments are not so limited. As would be apparent to one skilled in the art, various functions of software might also be implemented as processes of circuits. Such circuits might be employed in, for example, a single integrated circuit, a multi-chip module, a single card, or a multi-card circuit pack.

Described embodiments might also be embodied in the form of methods and apparatuses for practicing those methods. Described embodiments might also be embodied in the form of program code embodied in non-transitory tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing described embodiments. Described embodiments might can also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the described embodiments. When implemented on a general-purpose processor, the program code segments combine with the processor to provide a unique device that operates analogously to specific logic circuits. Described embodiments might also be embodied in the form of a bitstream or other sequence of signal values electrically or optically transmitted through a medium, stored magnetic-field variations in a magnetic recording medium, etc., generated using a method and/or an apparatus of the described embodiments.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various described embodiments.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard. Unless explicitly stated otherwise, each numerical value and range should be interpreted as being approximate as if the word “about” or “approximately” preceded the value of the value or range.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

It will be further understood that various changes in the details, materials, and arrangements of the parts that have been described and illustrated in order to explain the nature of the described embodiments might be made by those skilled in the art without departing from the scope expressed in the following claims.

We claim:

1. A method of tracking, by a media controller coupled to a solid-state media, a read disturb limit of the solid-state media, the method comprising:
receiving, by the media controller, a read operation from a host device coupled to the media controller;
by the media controller in response to the received read operation:
determining one or more associated regions of the solid-state media accessed by the read operation;
reading the one or more associated regions of the solid-state media to provide read data to the host device;
selectively incrementing, based on a probability value corresponding to each of the one or more associated regions, a read count of each of the one or more associated regions of the solid-state media;
determining, based upon the read count of each of the one or more associated regions, whether each region has reached a read disturb limit;
if a given region has reached the read disturb limit:
relocating data of the given region to a free region of the solid-state media;
otherwise, if the given region has not reached the read disturb limit
maintaining data in the given region.

2. The method of claim 1, wherein the probability value corresponding to each of the one or more associated regions comprises a global probability value, the method further comprising:
determining, by the media controller, the global probability value for all regions of the solid-state media.

3. The method of claim 1, wherein the probability value corresponding to each of the one or more associated regions comprises one or more separate probability values, the method further comprising:
determining, by the media controller, the one or more separate probability values, each of the one or more separate probability values corresponding with a given region of the solid-state media.

4. The method of claim 1, wherein the step of selectively incrementing, based on a probability value corresponding to each of the one or more associated regions, a read count of each of the one or more associated regions of the solid-state media further comprises:
generating a comparison value by one of (i) a pseudo-random number generator (PRNG) and (ii) a real-time clock;
comparing the probability value to the comparison value; and
selectively incrementing the read count of each of the one or more associated regions of the solid-state media according to the comparing;
otherwise:
maintaining the read count of each of the one or more associated regions of the solid-state media.

5. The method of claim 4, wherein the step of selectively incrementing, based on a probability value corresponding to each of the one or more associated regions, a read count of each of the one or more associated regions of the solid-state media further comprises:
incrementing the read count of each of the one or more associated regions of the solid-state media for fewer than ½ of read operations for the associated regions.

6. The method of claim 1, further comprising:
determining a desired granularity unit of the solid-state media; and
identifying the one or more associated regions according to the desired granularity unit, wherein the desired granularity unit determines the size of each of the one or more regions of the solid-state media.

7. The method of claim 6, further comprising:
determining a subset of a read disturb range over which to initialize each read count, the read disturb range based on the read disturb limit of the solid-state media;
selecting, for each read count, a value within the determined subset of the read disturb range; and
setting, for each read count, the given read count to the corresponding selected value within the determined subset of the read disturb range, thereby reducing a likelihood of multiple read counts reaching the read disturb limit substantially simultaneously.

8. The method of claim 7, wherein the step of selecting, for each read count, a value within the determined subset of the read disturb range comprises:
selecting each value at determined intervals within the determined subset of the read disturb range.

9. The method of claim 7, wherein the step of selecting, for each read count, a value within the determined subset of the read disturb range comprises:
selecting, based on an output of a pseudo-random number generator, each value as substantially random values within the determined subset of the read disturb range.

10. The method of claim 1, further comprising:
reducing the probability value over a lifetime of the solid-state media.

11. The method of claim 10, wherein the step of reducing the probability value over a lifetime of the solid-state media comprises:
determining whether the solid-state media has reached one of one or more program/erase cycle thresholds, and, if so:
reducing the probability value, wherein reducing the probability value is performed by one of: (i) reducing the probability value by a predetermined amount and (ii) setting the probability value to a predetermined value.

12. The method of claim 1, further comprising:
reducing the read disturb limit by a predetermined amount, thereby reducing a probability of exceeding the read disturb limit.

13. The method of claim 12, wherein the predetermined amount is substantially equal to an integer multiple of standard deviations determined based on the read disturb limit.

14. The method of claim 1, wherein, for the method, the solid-state media comprises a single type of memory.

15. The method of claim 1, wherein, for the method, the solid-state media comprises more than one type of memory.

16. The method of claim 1, wherein, for the method, the solid-state media comprises a multi-level cell (MLC) NAND flash memory.

17. A non-transitory machine-readable medium, having encoded thereon program code, wherein, when the program code is executed by a machine, the machine implements a method of tracking, by a media controller coupled to a solid-state media, a read disturb limit of the solid-state media, the method comprising:
receiving, by the media controller, a read operation from a host device coupled to the media controller;
by the media controller in response to the received read operation:
determining one or more associated regions of the solid-state media accessed by the read operation;
reading the one or more associated regions of the solid-state media to provide read data to the host device;
selectively incrementing, based on a probability value corresponding to each of the one or more associated regions, a read count of each of the one or more associated regions of the solid-state media;
determining, based upon the read count of each of the one or more associated regions, whether each region has reached a read disturb limit;
if a given region has reached the read disturb limit:
relocating data of the given region to a free region of the solid-state media;
otherwise, if the given region has not reached the read disturb limit:
maintaining data in the given region.

18. A media controller for a solid-state media, the media controller comprising:
tracking, by a media controller coupled to a solid-state media, a read disturb limit of the solid-state media, the method comprising:
an input/output interface configured to communicate with a host device coupled to the media controller;
a control processor coupled to the input/output interface, wherein the control processor is configured to, in response to the input/output interface receiving a read operation from the host device:
determine one or more associated regions of the solid-state media accessed by the read operation;
read, via a solid-state controller and a buffer of the media controller, the one or more associated regions of the solid-state media to provide read data to the host device via the input/output interface;
selectively increment, based on a probability value corresponding to each of the one or more associated regions, a read count of each of the one or more associated regions of the solid-state media;
determine, based upon the read count of each of the one or more associated regions, whether each region has reached a read disturb limit;
if a given region has reached the read disturb limit:
relocate data of the given region to a free region of the solid-state media;
otherwise, if the given region has not reached the read disturb limit:
maintain data in the given region.

19. The media controller of claim 18, wherein the probability value corresponding to each of the one or more associated regions comprises a global probability value, and the control processor is further configured to determine the global probability value for all regions of the solid-state media.

20. The media controller of claim 18, wherein the probability value corresponding to each of the one or more associated regions comprises one or more separate probability values, and the control processor is further configured to determine the one or more separate probability values, each of the one or more separate probability values corresponding with a given region of the solid-state media.

21. The media controller of claim 18, wherein the control processor is configured to:
generate a comparison value by one of (i) a pseudo-random number generator (PRNG) and (ii) a real-time clock.
compare the probability value to the comparison value; and
if the probability value and the comparison value are substantially equal:
selectively incrementing the read count of each of the one or more associated regions of the solid-state media according to the comparing;
otherwise:
maintaining the read count of each of the one or more associated regions of the solid-state media.

22. The media controller of claim 18, wherein the control processor is configured to:
determine a desired granularity unit of the solid-state media; and
identify the one or more associated regions according to the desired granularity unit, wherein the desired granularity unit determines the size of each of the one or more regions of the solid-state media.

23. The media controller of claim 22, wherein the control processor is further configured to:
determine a subset of a read disturb range over which to initialize each read count, the read disturb range based on the read disturb limit of the solid-state media;
select, for each read count, a value within the determined subset of the read disturb range; and
set, for each read count, the given read count to the corresponding selected value within the determined subset of the read disturb range, thereby reducing a likelihood of multiple read counts reaching the read disturb limit substantially simultaneously.

24. The media controller of claim 18, wherein the control processor is configured to reduce the probability value over a lifetime of the solid-state media.

25. The media controller of claim 24, wherein the control processor is further configured to:
determine whether the solid-state media has reached one of one or more program/erase cycle thresholds, and, if so:
reduce the probability value, wherein reducing the probability value is performed by one of: (i) reducing the probability value by a predetermined amount and (ii) setting the probability value to a predetermined value.

26. The media controller of claim 18, wherein the control processor is configured to reduce the read disturb limit by a predetermined amount, thereby reducing a probability of exceeding the read disturb limit.

27. The media controller of claim 18, wherein the solid-state media comprises one of: (i) a single type of memory and (ii) more than one type of memory.
